(19) United States
(12) Patent Application Publication
(10) Pub. No.: US 2024/0326748 A1
(43) Pub. Date: Oct. 3, 2024

(54) WISCHERVORRICHTUNG, WISCHERSYSTEM, FAHRZEUG UND VERFAHREN

(71) Applicant: Robert Bosch GmbH, Stuttgart (DE)

(72) Inventors: Helmut Depondt, Boutersem (BE); Marcello Bubba, Linden (BE)

(21) Appl. No.: 18/619,342

(22) Filed: Mar. 28, 2024

(30) Foreign Application Priority Data
Mar. 30, 2023 (DE) 102023202907.3

(51) Int. Cl. B60S 1/34; B60S 1/38; B60S 1/52

(52) U.S. Cl. CPC B60S 1/3415; B60S 1/3495; B60S 1/3886; B60S 1/522

(57) ABSTRACT

A wiper device, at least for cleaning a windshield of a vehicle and/or a sensor, having at least one wiper blade which is configured at least to sweep over at least a part of the windshield during a cleaning process, and which has at least one fastening unit at least for fixing the wiper blade to a wiper drive of the vehicle, in particular an output element of the wiper drive of the vehicle. It is proposed that the fastening unit is arranged in a longitudinal end section of the wiper blade.

### BACKGROUND

A wiper device has already been proposed, at least for cleaning a windshield of a vehicle and/or a sensor, with at least one wiper blade which is configured to sweep over at least a part of the windshield during a cleaning process and which has at least one fastening unit at least for fixing the wiper blade to a wiper drive of the vehicle.

### SUMMARY

The invention is based on a wiper device, at least for cleaning a windshield of a vehicle and/or a sensor, having at least one wiper blade which is configured at least to sweep over at least part of the windshield during a cleaning operation, and which has at least one fastening unit at least for fixing the wiper blade to a wiper drive of the vehicle, in particular an output element of the wiper drive of the vehicle.

It is proposed that the fastening unit is arranged in a longitudinal end section of the wiper blade.

The design of the wiper device according to the invention can advantageously provide low assembly complexity, since in particular a wiper arm can be dispensed with. Advantageously, a low-cost design can be provided, as additional components, such as a wiper arm, can be dispensed with, in particular by fastening the wiper blade to the wiper drive.

The term “wiper device” is preferably intended to mean at least one part, preferably a subassembly, of a windshield wiper. Preferably, the wiper device is intended for use on a vehicle, in particular a car and/or truck. Preferably, the wiper device forms at least part of the windshield wiper. Preferably, the wiper device, in particular as part of the windshield wiper, is designed to clean a surface, preferably a windshield, for example a vehicle windshield and/or a sensor field surface of the sensor and/or a headlight panes and/or the like, in particular on the vehicle. Preferably, the wiper device is coupled to a vehicle, preferably the at least one wiper drive of the vehicle, for cleaning the windshield, preferably the vehicle windshield, such as a front windshield and/or rear windshield. Preferably, the wiper device has at least one wiper blade, which is swept over the vehicle windshield and/or sensor field surface during a cleaning process, in particular if this is integrated in the vehicle windshield. An object being provided or designed or configured for a specific function is preferably understood to mean that the object fulfills and/or performs this specific function in at least one application and/or operating state. An “operating state” is preferably to be understood as a state in which the windshield wiper is ready for operation for a wiping process and/or a wiping operation and/or is in a wiping operation, in which the wiper device, preferably a wiper blade of the wiper device, in particular of the windshield wiper, preferably sweeps over the vehicle windshield and/or sensor field surface and, in doing so, preferably makes contact with the vehicle windshield.

Preferably, the at least one wiper drive of the vehicle is designed as an electric motor, for example a brushless DC electric motor, in particular an electrically commutated DC electric motor. Preferably, the electric motor is intended to provide a torque for a rotational movement of the windshield wiper, in particular the wiper device and/or the wiper blade, about the at least one wiper drive, in particular about a rotational axis of the wiper drive. Preferably, the electric motor has a motor output shaft, which is intended to provide a torque to drive the windshield wiper, in particular the wiper device and/or the wiper blade.

Preferably, the windshield wiper has at least one wiper. Preferably, the wiper has at least the wiper blade and/or the fastening unit. Preferably, the fastening unit is configured to fasten/fix the at least one wiper, in particular the wiper blade of the at least one wiper, to the at least one wiper drive, in particular the output element of the at least one wiper drive of the vehicle. In particular, the fastening unit is designed as a mechanical connection, preferably (non-destructively) detachable, such as a screw connection and/or a plug-in connection and/or a riveted connection or the like. It is conceivable that the fastening unit is configured as an alternative or in addition to a welded and/or adhesive connection or another material-locking connection. Preferably, the fastening unit is configured to transmit a torque and/or a rotational movement of the at least one wiper drive, in particular the output element of the at least one wiper drive of the vehicle, to the wiper, in particular to the wiper blade of the wiper about the axis of rotation of the at least one wiper drive. It is conceivable that the fastening unit comprises at least one adapter that fastens the wiper blade of the wiper directly to the wiper drive, in particular the output element of the wiper drive, for example with a screw connection and/or a clamp connection. In particular, the output element has at least one cantilever and/or eccentric, which is designed as a fastening unit corresponding to the fastening unit. In particular, the fastening unit is made of a metallic material. Alternatively, it is conceivable that the fastening unit is made of a plastic or composite material. Preferably, the fastening unit is made of a die-cast material, in particular a die-cast aluminum and/or a cast steel material.

Preferably, the wiper blade has one main direction of extension. In particular, a longitudinal direction of the wiper blade is arranged at least essentially parallel to the main direction of extension of the wiper blade. In particular, the longitudinal direction of the wiper blade is aligned/arranged at least essentially parallel to the windshield, in particular the vehicle windshield and/or sensor field surface and/or headlight panes, during a wiping operation of the windshield wiper. Preferably, the longitudinal end section comprising the fastening unit is arranged closer to the wiper drive than at least one other longitudinal end section of the wiper blade. For example, the wiper blade has at least two longitudinal end sections. In particular, the longitudinal end section of the wiper blade and the further longitudinal end section of the wiper blade are arranged in such a way that the longitudinal end section and the further longitudinal end section are at a maximum distance from each other. The term “main direction of extension” of an object is in this context in particular understood to mean a direction which extends parallel to a longest edge of a smallest geometrical cuboid, which just completely encloses the object.

It is further proposed that the longitudinal end section comprises a longitudinal end of the wiper blade and extends over at most 15%, preferably over at most 10%, of a total longitudinal extension of the wiper blade measured parallel to a main direction of extension of the wiper blade. Advantageously, low complexity and/or costs can be provided, as additional components, such as a wiper arm, can be dispensed with in particular by fastening the wiper blade to the wiper drive. Preferably, the longitudinal end section with the fastening unit is arranged at the longitudinal end of the wiper blade end that has the smallest radius of rotation. A “longitudinal end” is to be understood in particular as one of at least two, preferably opposite, points of a component which have the greatest possible direct distance to each other.

Furthermore, it is proposed that the fastening unit has at least one, in particular integrated, fluidic connection element which is configured to supply the wiper blade with wash water, in particular at least one wash water dispensing element. Advantageously, a particularly simple assembly can be provided, since in particular the fluidic connection element can be assembled automatically and/or error-free and/or self-centering during a mechanical assembly of the fastening unit with the wiper drive. Advantageously, a high reliability/lifetime/operational safety can be provided, as the integrated arrangement of the fluidic connection element of the fastening unit in particular protects the fluidic connection element from damage, especially mechanical damage. Preferably, the fastening unit has at least one base body. Preferably, the fluidic connection element is at least partially, preferably completely, integrated and/or arranged in the base body of the fastening unit. In particular, the fluidic connection element is enclosed on at least four sides by the base body of the fastening unit. Preferably, the fluidic connection element is connected to the base body of the fastening unit in a form-fit and/or material-fit manner. Preferably, the fluidic connection element is configured to be connected to a corresponding fluidic connection element of the wiper drive in the longitudinal direction of the wiper blade. Preferably, the fluidic connection element is configured to conduct a wash water. In particular, the fluidic connection element has a flow direction. In particular, the fluidic connection element is connected to a wash water pipe, preferably in one piece. It is conceivable that the fluidic connection element is connected to a wash water channel of the wiper blade in a fluid-tight, preferably one-piece, manner. In particular, the direction of flow of the wash water, especially in the fluidic connection element, is arranged at least essentially parallel to the longitudinal direction of the wiper blade. In particular, a flow area of the fluidic connection element is arranged at least substantially perpendicular to the longitudinal direction of the wiper blade. For example, the fluidic connection element is designed as a hose connector and/or a quick-release coupling. The term “washing water” is to be understood in particular as water and/or a mixture of water and additives, such as antifreeze and/or corrosion inhibitors and/or cleaning agents and/or fragrances and/or the like.

Furthermore, it is proposed that the fastening unit has at least one, in particular integrated, electrical connection element which is configured to supply power, in particular to at least one temperature control element, to the wiper blade. Advantageously, a high level of operational reliability can be provided, as the wiper blade can be tempered, in particular by the electrical connection element, thus enabling operation at very low outside temperatures, especially when starting the vehicle. Advantageously, a particularly simple assembly can be provided, since in particular the electrical connection element can be assembled automatically and/or error-free and/or self-centering during a mechanical assembly of the fastening unit with the wiper drive. Advantageously, a high level of reliability/lifetime/operational safety can be provided, as the integrated arrangement of the electrical connection element of the fastening unit in particular protects the electrical connection element from damage, especially mechanical damage. Preferably, the electrical connection element is at least partially, preferably completely, integrated and/or arranged in the base body of the fastening unit. In particular, the electrical connection element is enclosed on at least four sides by the base body of the fastening unit. Preferably, the electrical connection element is connected to the base body of the fastening unit in a form-fit and/or material-fit manner. Preferably, the electrical connection element is arranged parallel to the fluidic connection element. It is conceivable that the electrical connection element is formed in one piece with the fluidic connection element. It is conceivable that the electrical connection element is formed by the base body of the fastening unit. Preferably, the electrical connection element is configured to be connected to a corresponding electrical connection element of the wiper drive in the longitudinal direction of the wiper blade. Preferably, the electrical connection element is configured to conduct an electrical current, in particular measuring current for temperature measurement and/or heating current to supply a wiper blade heater and/or a control current to control the washer fluid dispenser and/or another electrical component that appears useful to the person skilled in the art. In particular, the electrical connection element is designed as an electrical plug connection, such as an electrical connector plug.

In addition, it is proposed that the fastening unit has at least one fastening element, which interacts in particular with a corresponding fastening element of the wiper drive and is arranged on a front side of the wiper blade. Advantageously, a low assembly complexity can be provided, since in particular a fixation of the fastening unit with the corresponding fastening element of the wiper drive is automatically fixed during assembly. Preferably, the front side is arranged perpendicular to the main direction of extension of the wiper blade. Preferably, the front side is flush with an outermost point of the longitudinal extension of the wiper blade. For example, the fastening element arranged on the front side of the wiper blade could be designed as a magnetic and/or mechanical connection.

In addition, it is proposed that the fastening unit has at least one fastening element which is designed as a form-fit element for producing a form-fit and/or latching connection with the wiper drive. Advantageously, a particularly simple assembly can be provided, as the latching connection in particular can be assembled and/or disassembled via plug & play. Preferably, the fastening element of the fastening unit has a positive latching element, in particular a spring-actuated one, which is configured to be connected to a negative latching element of the wiper drive. Alternatively, the fastening element of the fastening unit could be designed as a negative latching element, which is configured to be connected to a positive latching element of the wiper drive. It is conceivable that the form-fit connection is designed as a split pin and/or bolt connection. Preferably, the form-fit and/or latching connection is designed as a detachable connection, in particular without tools. A “negative” latching element should be understood in particular as a depression and/or an opening. A “positive” latching element should be understood to mean an elevation, such as a fastener or similar.

Furthermore, it is proposed that the fastening unit, in particular the fastening element, is formed in one piece with the wiper blade, preferably with a functional component of the wiper blade. Advantageously, simple assembly can be provided, as the fastening unit and the wiper blade in particular are already firmly connected. Advantageously, a low level of complexity can be provided, as the fastening unit and the wiper blade in particular are already connected to each other. In particular, the fastening unit is formed by at least one of the functional components of the wiper blade, preferably by the wiper blade. By the fact that two units are “partially in one piece”, it should be understood in particular that the units have at least one, in particular at least two, advantageously at least three common elements which are a component, in particular a functionally important component, of both units. A “functional component” is to be understood in particular as a component that has a fixed function in the wiper blade, such as a wiper strip, end cap, wiper lip, wiper spring or spoiler. In particular, the functional component is not formed as an adapter for a, preferably universal, connection of two components.

Furthermore, it is proposed that the fastening unit, in particular the fastening element, is formed in one piece, preferably at least partially monolithically, with an end cap of the wiper blade, which is configured in particular to hold together at least one wiper strip. Advantageously, a long service life of the wiper device can be provided, as the one-piece, preferably at least partially monolithic, connection in particular is very stable and does not require maintenance. Advantageously, a low level of assembly complexity can be provided, as the number of parts to be assembled is low, in particular due to the one-piece design of the end cap and the fastening unit. In particular, the fastening unit is at least partially formed by the end cap. In particular, the end cap is formed in one piece with the wiper blade, preferably at least one of the functional components of the wiper blade. In particular, the base body of the fastening unit is formed at least as the end cap.

Furthermore, it is proposed that the fastening unit is configured for direct and/or wiper arm-free fastening of the wiper blade to the wiper drive. Advantageously, a low level of assembly complexity can be provided, as the number of parts to be assembled is low, in particular due to the one-piece design of the end cap and the fastening unit. Advantageously, costs can be reduced, as additional components, such as the wiper arm, can be dispensed with, in particular by fastening the wiper blade to the wiper drive. The wiper blade could be connected directly to an output element of the wiper arm drive via the fastening unit. Preferably, the length of the output element is significantly shorter, in particular at least 50% shorter, preferably at least 70% shorter than the total longitudinal extension of the wiper blade. Preferably, the fixing of the wiper blade to the output element of the wiper drive is free of additional connecting elements, such as adapters, which connect the wiper blade to the vehicle. In particular, the fastening unit is configured to fix the wiper blade directly to the output element of the wiper drive, preferably without an adapter, in particular without a wiper blade adapter.

It is also proposed that the fastening unit provides an assembly direction which is arranged at least substantially parallel to a main direction of extension of the wiper blade. Advantageously, a particularly simple assembly can be provided, since in particular the wiper blade can be conveniently assembled/fixed with the wiper drive in a rest position of the wiper drive in the longitudinal direction of the wiper blade from at least one side of the vehicle having the wiper drive. Preferably, the assembly direction of the fastening unit is at least essentially parallel to a connection direction of the electrical connection element and/or the fluidic connection element. Alternatively, it is conceivable that the assembly direction could be arranged at least essentially perpendicular or at an angle to the main direction of extension of the wiper blade. It is conceivable that the assembly direction has a minimum angle of at least 10°, preferably at least 30° and preferably at least 45°, to the main direction of extension of the wiper blade. The term “substantially parallel” is in particular intended here to be understood to mean an orientation of a direction relative to a reference direction, in particular in a plane, wherein the direction has a deviation from the reference direction of in particular less than 8°, advantageously less than 5°, and in particular advantageously less than 2°.

A wiper system with a wiper drive and a wiper device is also proposed. A low level of assembly complexity can be provided as there is no need for a wiper arm in particular. Advantageously, a low-cost design can be provided, as additional components, such as a wiper arm, can be dispensed with, in particular by fastening the wiper blade to the wiper drive.

Furthermore, a vehicle with a windshield and/or with a sensor and with the wiper device is proposed, which preferably has a wiper system. A high operational reliability of the vehicle can be provided as the wiper device in particular provides a high cleaning performance of the windshield/sensor. A low level of assembly complexity can be provided as there is no need for a wiper arm in particular. Preferably, the wiper blade sweeps over the windshield and/or the vehicle's sensor, making contact. Advantageously, a low-cost design can be provided, as additional components, such as a wiper arm, can be dispensed with, in particular by fastening the wiper blade to the wiper drive.

In addition, a method is proposed for assembling a wiper blade, in particular by means of a wiper device, wherein the wiper blade is assembled on a vehicle in a method step, wherein in the method step a fastening unit arranged in a longitudinal end section of the wiper blade is fixed, preferably directly, to a wiper drive of the vehicle, in particular an output element of the wiper drive of the vehicle. A low level of assembly complexity can be provided as there is no need for a wiper arm in particular. Advantageously, a low-cost design can be provided, as additional components, such as a wiper arm, can be dispensed with, in particular by fastening the wiper blade to the wiper drive. Preferably, the fastening unit and the output element of the wiper drive are pushed into each other. When assembling the fastening unit with the output element of the wiper drive, the latching element of the fastening unit is latched with the latching element of the wiper drive, in particular the output element of the wiper drive. The electrical connection element and/or the fluidic connection element is connected to the corresponding electrical connection element and/or fluidic connection element of the wiper drive when the fastening unit of the wiper blade and the output element of the fastening unit are pushed into one another. It is conceivable that the output element is designed as the wiper drive.

In addition, it is proposed that when carrying out the method step, the wiper blade is fixed to the wiper drive in a single assembly movement and at the same time a fluidic connection element of the wiper blade and/or an electrical connection element of the wiper blade is connected, in particular to the respective counterpart of the wiper drive. Advantageously, a particularly high assembly quality can be provided, as assembly errors can be prevented in particular by the automatic/simultaneous assembly of the fluidic and/or electrical connection element during the mechanical assembly of the fastening unit with the wiper drive. A low level of assembly complexity can be provided as there is no need for a wiper arm in particular. In particular, the counterpart is designed as a fluid and/or electrical connection element corresponding to the fluidic connection element and/or the electrical connection element.

The wiper device according to the invention, the wiper system according to the invention, the vehicle according to the invention and the method according to the invention are not intended to be limited to the application and embodiment described above. In particular, the wiper device according to the invention, the wiper system according to the invention, the vehicle according to the invention and the method according to the invention can have a number of individual elements, components and units as well as method steps that differs from a number mentioned herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. The drawings illustrate an embodiment example of the invention. The drawings, the description, and the disclosure contain numerous features in combination. A person skilled in the art will appropriately also consider the features individually and combine them into additional advantageous combinations.

Shown are:

FIG. 1 a vehicle with a windshield, with a wiper drive and with a wiper device,

FIG. 2 the wiper device with a fastening element and with a fluidic and an electrical connection element and

FIG. 3 a schematic flow diagram of a method for assembling the wiper device.

### DETAILED DESCRIPTION

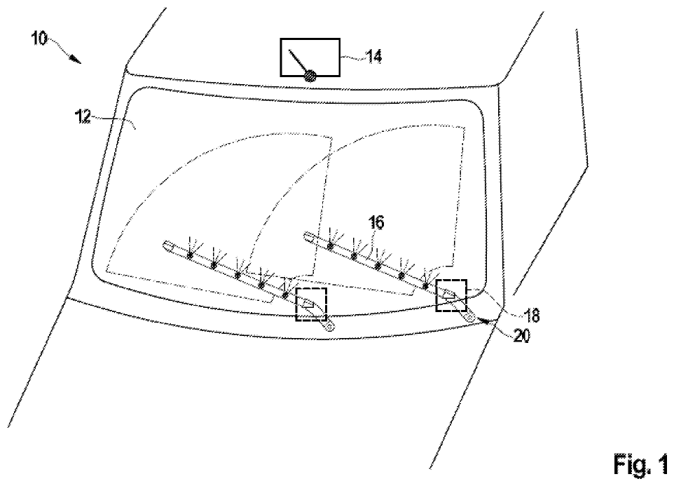

FIG. 1 shows a vehicle 10. The vehicle 10 is designed as an autonomous and/or semi-autonomous and/or manually operated vehicle 10. The vehicle 10 is designed as a car. The vehicle 10 could also be designed as a truck or a ship and/or an airplane or a drone or a train or the like. The vehicle 10 has a sensor 14. The vehicle 10 has a windshield 12. The windshield 12 is designed as a front windshield. The windshield 12 could also be designed as a rear windshield, sensor pane, headlight pane or similar. The vehicle 10 has a wiper system. The vehicle 10 has a wiper drive 20. The wiper system has the wiper drive 20. The vehicle 10 has a wiper device. The wiper system of the vehicle 10 has the wiper device. The wiper system has an electric motor. The electric motor is configured to drive the wiper device. The wiper device has a wiper blade 16. The wiper device is configured to clean the windshield 12 of the vehicle 10. Alternatively or additionally, the wiper device is configured to clean the pane of the sensor 14. The wiper blade 16 is configured to sweep over part of the windshield 12 during a cleaning process. The wiper blade 16 contacts the windshield 12 during cleaning. The wiper device has a fastening unit 18. The fastening unit 18 is configured to fasten the wiper blade 16 to the wiper drive 20.

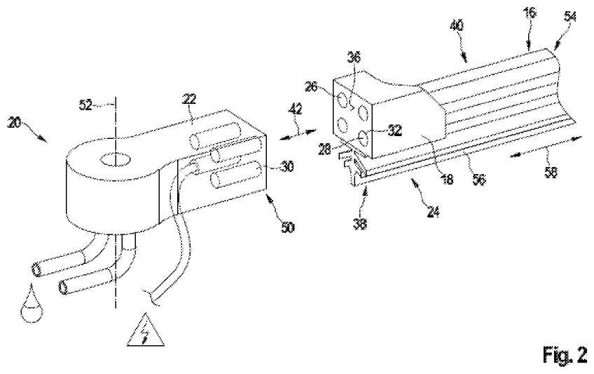

FIG. 2 shows the wiper device. The fastening unit 18 of the wiper device is configured to fix the wiper blade 16 to an output element 22 of the wiper drive 20. In one operation, the output element 22 rotates about an axis of rotation 52. The output element 22 is permanently connected to a motor output shaft of the electric motor. The output element 22 has a cantilever. The cantilever has a fastening element 30. The fastening unit 18 is arranged in a longitudinal end section 24 of the wiper blade 16. The longitudinal end section 24 comprises a longitudinal end of the wiper blade 16. The longitudinal end section 24 extends over at most 10% of a total longitudinal extension of the wiper blade 16 measured parallel to a main direction of extension 58 of the wiper blade 16. The fastening unit 18 has two integrated fluidic connection elements 26. The output element 22 has electrical and fluidic counterparts 50. The fluidic connection elements 26 are configured to supply wash water to a wash water dispensing element of the wiper blade 16. The fluidic connection elements 26 are designed as recesses, which are configured to accommodate corresponding connector plugs of the wiper drive 20. Alternatively, the fluidic connection elements 26 could also be designed as plugs, which are configured to be inserted into corresponding recesses on the output element 22 of the wiper drive 20. The fastening unit 18 has two integrated electrical connection elements 28. The electrical connection elements 28 are configured to supply power to a temperature control element of the wiper blade 16. The electrical connection elements 28 are configured as recesses, which are set up to accommodate corresponding connector plugs of the wiper drive 20. Alternatively, the electrical connection elements 28 could also be configured as plugs, which are designed to be plugged into corresponding recesses on the wiper drive 20. Alternatively, the fastening unit 18 could have only one or more than two electrical connection elements 28. Alternatively, the fastening unit 18 could have only one or more than two fluidic connection elements 26. It is conceivable that the fastening unit 18 is free of electrical and/or fluidic connection elements. The fastening unit 18 has a fastening element 32 that interacts with the corresponding fastening element 30 of the wiper drive 20. The fastening element 32 is arranged on/at a front side 36 of the wiper blade 16. The fastening element 32 is designed as a form-fit element for producing a form-fit and/or latching connection with the wiper drive 20. The form-fit element could be designed as the electrical connection elements 28 and/or the fluidic connection elements 26. Alternatively or additionally, the fastening unit 18 could have a latching element. The fastening element 32 is formed in one piece with a functional component of the wiper blade 16. The functional component is designed as a wiper strip 40 of the wiper blade 16. The fastening element 32 is formed in one piece with the wiper blade 16. Alternatively, the fastening element 32 could be designed as a magnet. It is conceivable that the fastening element 32 is arranged on a side of the electrical connection elements 28 and/or fluidic connection elements 26 opposite the wiper blade 16. It is conceivable that the fastening element 32 is arranged on one side of the fastening unit. The fastening element 32 could be designed as a spring-loaded snap fastener/latching hook. The fastening element 30 could be designed as a recess. The recess could be configured to accommodate the fastener/latching hook. Alternatively, the fastening element 30 could be designed as the spring-loaded snap fastener/latching hook. Alternatively, the fastening element 32 would be designed as the corresponding recess. The fastening unit 18 is monolithic with an end cap 38 of the wiper blade 16. The end cap 38 is integrated into the fastening unit 18. The fastening unit 18 is configured to hold the wiper blade 16 together. The end cap 38 is configured to hold the wiper strip 40 together. The wiping strip 40 comprises a wiper lip 56. The wiper strip 40 comprises two wiper springs. The wiper blade 16 has a further end cap 54. The further end cap 54 is arranged at the end of the wiper blade 16 opposite the fastening unit 18. The other end cap 54 is configured to hold the wiper strip 40 together. The fastening unit 18 is configured for direct and/or wiper arm-free fastening of the wiper blade 16 to the wiper drive 20. The fastening unit 18 is firmly connected to the wiper blade 16. The fastening unit 18 could be detachably connected to the wiper blade 16. The fastening unit 18 specifies an assembly direction 42. The assembly direction 42 is arranged parallel to the main direction of extension 58 of the wiper blade 16. The fastening element 32 can be assembled parallel to the assembly direction 42. The fastening element 32 could be movable/actuable perpendicular to the assembly direction 42.

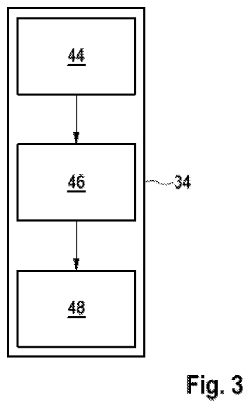

FIG. 3 shows a schematic flow diagram of a method for assembling the wiper blade 16 with the wiper drive 20. In a method step 34, the wiper blade 16 is assembled on a vehicle 10. In method step 34, the fastening unit 18 arranged in the longitudinal end section 24 of the wiper blade 16 is fixed directly to the output element 22 of the wiper drive 20 of the vehicle 10. When carrying out method step 34, the wiper blade 16 is fixed to the wiper drive 20 in a single assembly movement. In method step 34, the fastening unit 18 and the output element 22 of the wiper drive 20 are pushed into one another. The fastening unit 18 is pushed over the output element 22 or into the output element 22.

In a substep 44, the form-fit element 32 is connected to the corresponding form-fit element 30 of the output element 22 while the fastening unit 18 and the output element 22 of the fastening unit 18 are being pushed into one another.

In a further substep 46, the fluidic connection element 26 of the wiper blade 16 is simultaneously connected to a respective counterpart 50 of the wiper drive 20. The fluidic connection element 26 is pushed into the corresponding fluidic connection element of the output element 22.

In a further substep 48, the electrical connection element 28 of the wiper blade 16 is simultaneously connected to the respective counterpart 50 of the wiper drive 20. The electrical connection element 28 is pushed into the corresponding electrical connection element of the output element 22.

1. A wiper device, at least for cleaning a windshield (12) of a vehicle (10) and/or a sensor (14), having at least one wiper blade (16) which is configured at least to sweep over at least a part of the windshield (12) during a cleaning operation, and which has at least one fastening unit (18) at least for fixing the wiper blade (16) to a wiper drive (20) of the vehicle (10), wherein the fastening unit (18) is arranged in a longitudinal end section (24) of the wiper blade (16).

2. The wiper device according to claim 1, wherein the longitudinal end section (24) comprises a longitudinal end of the wiper blade (16) and extends over at most 15%, of a total longitudinal extension of the wiper blade (16) measured parallel to a main direction of extension (58) of the wiper blade (16).

3. The wiper device according to claim 1, wherein the fastening unit (18) has at least one fluidic connection element (26) which is configured for at least one washing water dispensing element, of the wiper blade (16).

4. The wiper device according to claim 1, wherein the fastening unit (18) has at least one electrical connection element (28) which is configured to supply power to the wiper blade (16).

5. The wiper device according to claim 1, wherein the fastening unit (18) has at least one fastening element (32) which interacts with a corresponding fastening element (30) of the wiper drive (20) and is arranged on a front side (36) of the wiper blade (16).

6. The wiper device according to claim 1, wherein the fastening unit (18) has at least one fastening element (32) which is designed as a form-fit element for producing a form-fit and/or latching connection with the wiper drive (20).

7. The wiper device according to claim 1, wherein the fastening unit (18), is formed in one piece with the wiper blade (16), and with a functional component of the wiper blade (16).

8. The wiper device according to claim 1, wherein the fastening unit (18), is formed in one piece with an end cap (38) of the wiper blade (16), which end cap is configured to hold together at least one wiper strip (40).

9. The wiper device according to claim 1, wherein the fastening unit (18) is configured for direct and/or wiper arm-free fastening of the wiper blade (16) to the wiper drive (20).

10. The wiper device according to claim 1, wherein the fastening unit (18) specifies an assembly direction (42) which is arranged at least substantially parallel to a main direction of extension (58) of the wiper blade (16).

11. A wiper system with a wiper drive (20) and with a wiper device according to claim 1.

12. A vehicle (10) with a windshield (12) and/or with a sensor (14) and with the wiper device according to claim 11.

13. A method for assembling a wiper blade (16), by means of a wiper device according to claim 1, wherein the wiper blade (16) is assembled on a vehicle (10) in a method step (34), wherein in the method step (34), a fastening unit (18) arranged in a longitudinal end section (24) of the wiper blade (16) is fixed to a wiper drive (20) of the vehicle (10), and to an output element (22) of the wiper drive (20) of the vehicle (10).

14. The method according to claim 13, wherein when carrying out the method step (34), the wiper blade (16) is fixed to the wiper drive (20) in a single assembly movement and at the same time a fluidic connecting element (26) of the wiper blade (16) and/or an electrical connecting element (28) of the wiper blade (16) is connected, in and to the respective counterpart (50) of the wiper drive (20).
